(19) United States
(12) Patent Application Publication
(10) Pub. No.: US 2009/0083629 A1
(43) Pub. Date: Mar. 26, 2009

(54) METHOD AND APPARATUS FOR IMPLEMENTING DIRECT PLAY OF MULTI-MEDIA INFORMATION

(75) Inventors: Maurice Hebben, Helmond (NL); Ronald Geerlings, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,133

(22) PCT Filed: Nov. 11, 2005
(86) PCT No.: PCT/IB2005/053722

§ 371 Date: May 11, 2007

Related U.S. Application Data
(60) Provisional application No. 60/627,695, filed on Nov. 12, 2004.

(51) Int. Cl. G06F 3/048

(52) U.S. Cl. 715/716

(57) ABSTRACT

A method and apparatus for controlling the presentation of multi-media content stored on a medium containing a plurality of multi-media content (100-195) are disclosed. The method comprises the steps of identifying the multi-media content from an identification (100) associated with the content and/or the medium, determining the location of a desired one (195) of the plurality of multi-media content (100-195) in response to a known input and the associated identification (100), storing the identification (100) associated with the desired content (195) and/or medium and displaying the desired multi-media content (195) from the determined location. In one aspect of the invention the identification of the multi-media content is compared to stored identifications and when a match is found, selected ones of the plurality of multi-media content are not presented under operator control.

This application is related to the multi-media presentation and, more particularly, to a method and system for controlling the start of the multi-media presentation.

On most commercial DVD-video discs, it is not possible to start the main movie right away. Typically, the main movie is preceded by other content. For example, the disc may contain video images, still pictures, and/or animated menus that represent announcements of new movies, film studio logos, FBI-warnings regarding copyright laws, etc.

For many users it is inconvenient to always have to watch this additional multi-media content, which is referred to herein as video content or data, before the start of the movie, especially when a disc is played more than once. For example, a child may repeatedly watch the same movie four or five times a day. In each case, the child has to watch all the preceding content as the disc is re-inserted or re-started. This can be very annoying to the child who simply wants to see the movie and does not want to or cannot interact with the menus displayed. In this case, the parent is forced to control the sequence necessary to start the main movie and, thus, must wait to proceed through each screen and menu.

Current DVD-video players cannot jump directly to the main movie because the video contents before the start of the movie are blocked by user operation prohibited (UOP) commands. For example, conventional DVD-video discs include a “First Play Program Chain,”—(FP_PGC), which is present or located in VMGI. Almost all commercial DVD-Video discs have a FP_PGC correctly specified to automatically start the first video content or menu. This is also referred to as “the beginning of the disc.”

Even if it were possible to skip preceding content by overruling the blocked commands, the user still needs to press many buttons on the remote control, for example, to set up the proper playing conditions.

Hence, there is a need in the industry for a method and apparatus to allow a user to jump directly to the beginning of a desired video content when a DVD-video disc is played.

A method and apparatus for controlling the presentation of multi-media content stored on a medium containing a plurality of multi-media content are disclosed. The method comprises the steps of identifying the multi-media content from an identification associated with the content and/or the medium, determining the location of a desired one among the plurality of multi-media content in response to a known input and the associated identification, storing the identification associated with the desired content and/or medium, and displaying the desired multi-media content from the determined location. In one aspect of the invention the identification of the multi-media content is compared to stored identifications and when a match is found, the selected ones of the plurality of multi-media content are not presented under operator control.

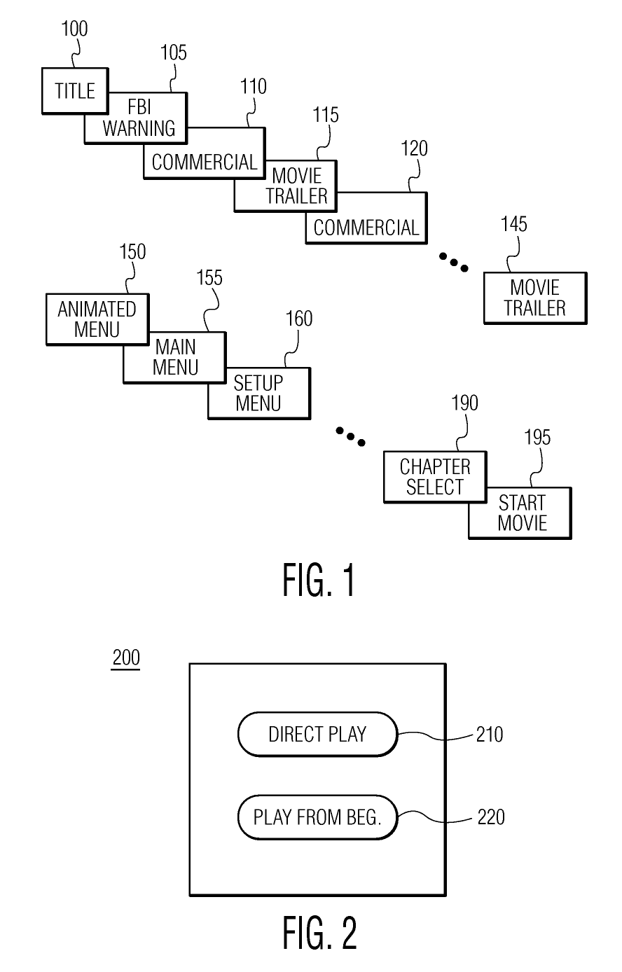

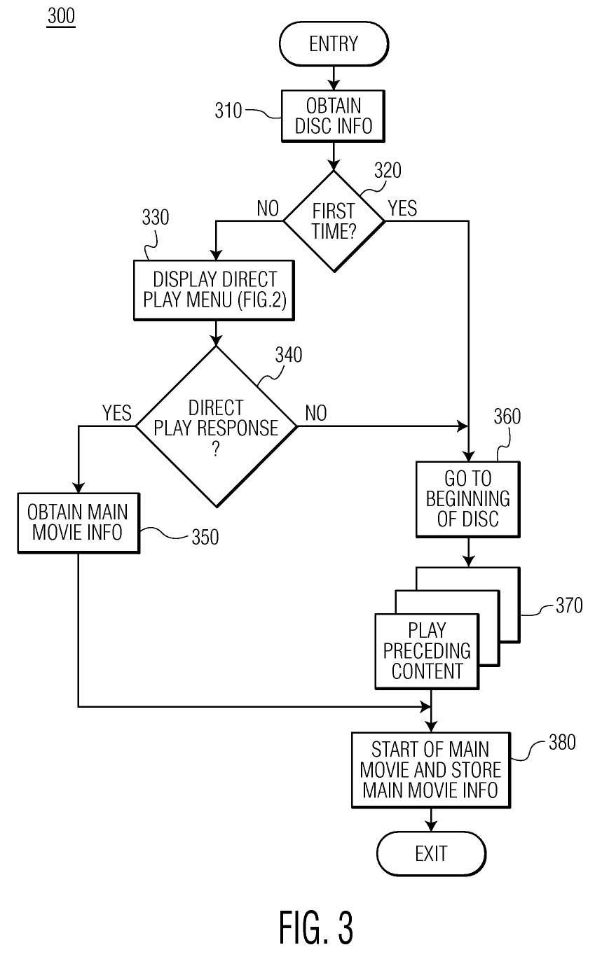

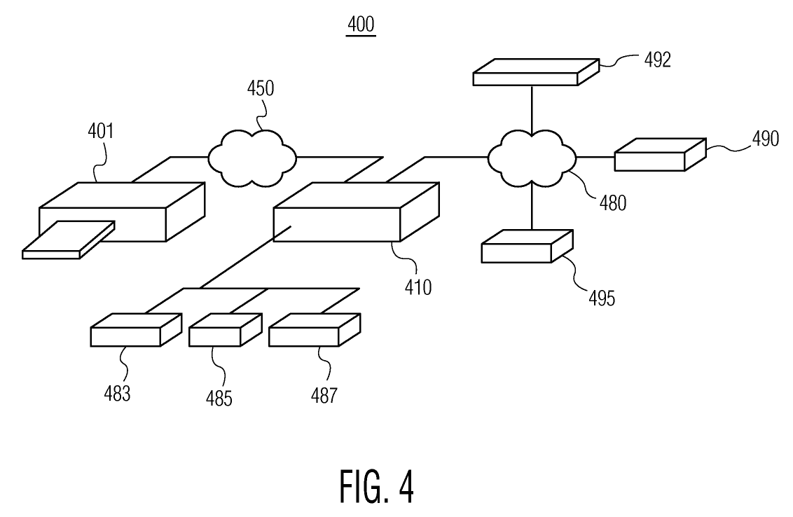

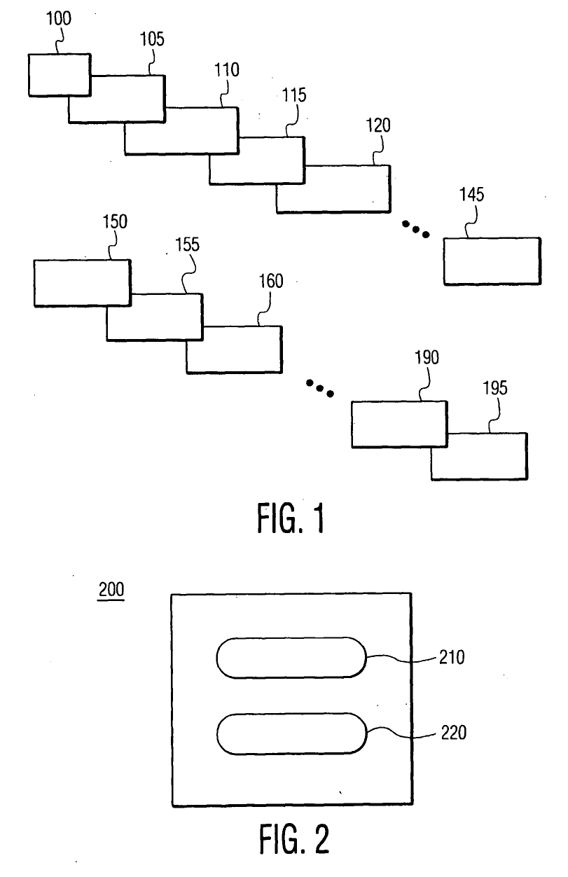

FIG. 1 illustrates an exemplary sequence of conventional screen displays;

FIG. 2 illustrates an exemplary screen display in accordance with the principles of the present invention;

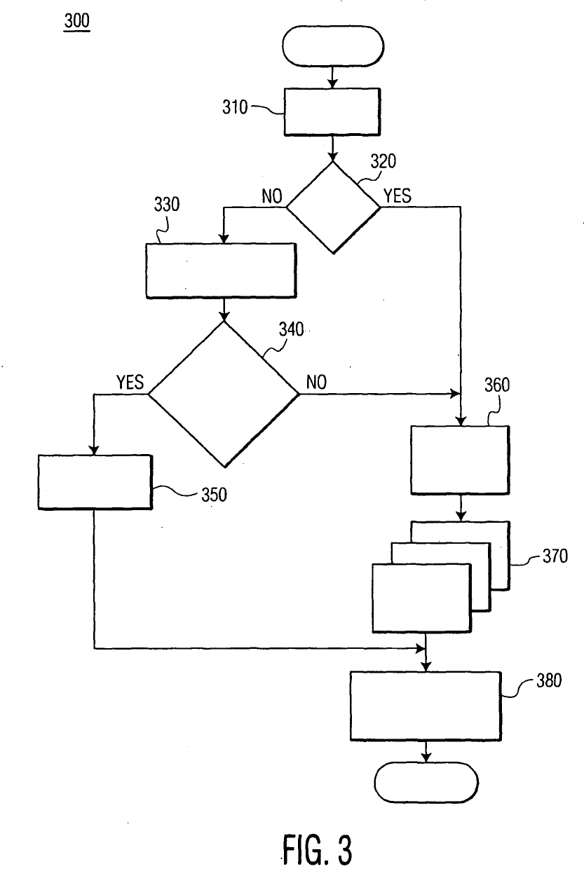

FIG. 3 illustrates a flow chart of an exemplary process in accordance with the principles of the present invention; and

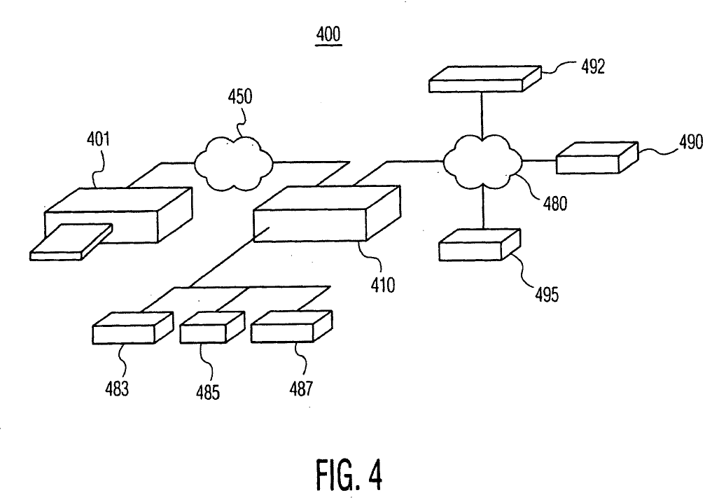

FIG. 4 illustrates an apparatus for performing the processing shown herein.

FIG. 1 illustrates an exemplary sequence of screen displays that are conventionally displayed when a DVD-Video disc is inserted into a DVD player. As shown, a title menu 100 may be displayed, typically for up to 30 seconds, a second display 105 showing an FBI warning informing the public that the images are protected by U.S. and Foreign copyright laws and the penalty for copyright infringement. This screen may also be displayed for up to 30 seconds. A third display 110 may illustrate, for example, a typical commercial for a related, or unrelated, product. This may be displayed for up to 2-3 minutes. A fourth display 115 may be an advertisement for a new film (movie trailer) that will soon be available. Displays 120-145, which represent additional commercials and/or movie trailers may then be shown. Each of these displays may last 1 to 3 minutes. Additional displays 150-190 may then be displayed. These displays may represent displays that require interactive operations that may or must be performed before the desired movie 195 is presented. Thus, a significant amount of time may be spent watching content that is not relevant to the desired video content on the disc.

FIG. 2 illustrates an exemplary display 200 in accordance with the principle of the invention. In this embodiment of the invention, screen display 200 is displayed prior to the display screens shown in FIG. 1. Display screen 200 provides the user with an interactive means to respond to a request of whether to directly play the video content stored on the medium (e.g., disc), by engaging button 210, or to begin playing the video content from the beginning of the disc, by engaging button 220.

FIG. 3 illustrates a flow chart of an exemplary process 300 for controlling the presentation of DVD video content in accordance with the principles of the invention. In this exemplary process, information regarding the unique identification of the disc is obtained at block 310. At block 320, a determination is made whether the unique identification of the disc is the same as one of the stored identifications of previously played discs, i.e., this is the first time the disc has been played. If the answer is negative, then the interactive direct play menu (see FIG. 2) is displayed at block 330.

At block 340 a determination is made whether a response to the request made by the interactive direct play menu or screen has been received and indicates (points to)? directly the desired content. If the answer is affirmative, then information regarding the main presentation, i.e., desired multi-media content, is obtained at block 350. This information may include, for example, the VTS number, Title number, subtitle and audio settings, etc. Such information is well-known in the art and need not be discussed herein. (Processing then to block 380 wherein the main movie or desired content is started and the information regarding the movie—e.g., unique identification, subtitle, audio setting, etc.—are saved.

However, if the answer is negative—i.e., “do not directly play desired content,” the processing proceeds to block 360, where information regarding the beginning of the disc, e.g., a FP_PGC in the VMGI, is obtained. PGC and VMGI are well known in the art and need not be discussed in detail herein. The content stored on the disc from the beginning, e.g., first frame, of the plurality of multi-media content is then displayed at block 370 (FIG. 1). As it would be appreciated, the first frame of the plurality of the multi-media content may or may not represent the physical beginning of the plurality of the multi-media content. Similarly, although the plurality of multi-media content is, conventionally, the beginning of the disc, this may also be the case and would be well-understood in the art. Processing proceeds to block 380 wherein the main movie is started and the information regarding the movie, e.g., unique identification, title number, subtitle, audio setting, etc., are saved as previously described.

Returning to the determination at block 320, if the answer is affirmative, processing proceeds to block 360 to obtain information from the beginning of the multi-media content, which is conventionally the beginning of the disc, as previously described.

FIG. 4 illustrates an exemplary embodiment of a system 400 that may be used for implementing the principles of the present invention. System 400 includes a processing section 410 that may contain one or more input/output devices 402, processors 403 and memories 404 (not shown). I/O devices 402 may access or receive information from one or more sources 401. Sources 401 may be devices such as a television system, DVD players/recorders, computers, notebook computer, PDAs, cell phones or other devices suitable for providing the information to execute the processing shown herein. Devices 401 may provide information over one or more network connections 450 via, for example, internal communication bus (analog or digital), a wireless wide area network, a wireless metropolitan area network, a wireless local area network, a terrestrial broadcast system (Radio, TV), a satellite network, a cell phone, or a wireless telephone network, as well as portions or 4; combinations of these and other types of networks.

Input/output devices 402, processors 403 and memories 404 may communicate over a communication medium 425. Communication medium 425 may represent, for example, a bus, a communication network, one or more internal connections of a circuit, circuit card or other apparatus, as well as portions and combinations of these and other communication media. Input data or information from the client devices 401 is processed in accordance with one or more programs that may be stored in memories 404 and executed by processors 403. Processors 403 may be any means, such as a general-purpose or special-purpose computing system, or it may be a hardware configuration, such as a laptop computer, desktop computer, a server, handheld computer, dedicated logic circuit, or integrated circuit. Processors 403 may also be Programmable Array Logic (PAL), Application Specific Integrated Circuit (ASIC), etc., which may be hardware “programmed” to include software instructions or a code that provides a known output in response to known inputs. In one aspect, hardware circuitry may be used in place of, or in combination with, software instructions to implement the invention. The elements illustrated herein may also be implemented as discrete hardware elements that are operable to perform the operations shown using coded logical operations or by executing a hardware executable code.

In one aspect, the principles of the present invention may be implemented by a computer-readable code executed by processor 403. The code may be stored in the memory 404 or read/downloaded from a memory medium 483, an I/O device 485 or magnetic/optical media such as a floppy disk, a CD-ROM or a DVD, 487.

Information items from device 401 received by I/O device 402, after processing in accordance with one or more programs operable to perform the functions illustrated herein, may also be transmitted over network 480 to one or more output devices represented as display 492, reporting device 490 or second processing system 495. For example, display 492 may be a conventional television, whether CRT, LCD or plasma. Network 480 may be the same or different network or network type as that of network 450.

As one skilled in the art would recognize, the term computer or computer system may represent one or more processing units in communication with one or more memory units and other devices, e.g., peripherals, connected electronically to and communicating with at least one processing unit. Furthermore, the devices may be electronically connected to one or more processing units via internal buses, e.g., ISA bus, microchannel bus, PCI bus, PCMCIA bus, etc., or one or more internal connections of a circuit, circuit card or other device, as well as portions and combinations of these and other communication media or an external network, e.g., the Internet and Intranet.

While there has been shown, described, and noted fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. For example, while the present invention has been described with regard to initiating a positive response to the screen shown in FIG. 2, it would be within the skill of those practicing in the art to expand the concept shown herein to other means for initiating the direct play mode. For example, in one aspect, the PLAY button on the DVD player or a remote control unit may be held for an extended period of time (e.g., at least 3 seconds). In another aspect, the separate buttons may be used on either a DVD player or a remote control unit to initiate a direct play mode. In still another aspect, the interactive direct play screen may be displayed at the start-up of the DVD disc or may be an option on the DVD player setup menu.

Furthermore, although the invention has been described with regard to multi-media stored on DVD discs, it would be recognized that other forms of media may be similarly used. For example, multi-medium content may be stored on a magnetic media such as a computer disc drive. In this case, the multi-media content may not be located at the exact beginning of the disc drive and, hence, the reference to the beginning would be with respect to the beginning of the content and not the physical location. This is also true with regard to DVD discs.

Accordingly, it is expressly intended that all combinations of those elements that perform substantially the same function, in substantially the same way, to achieve the same results are within the scope of the invention. Substitutions of elements from one described embodiment to another are also fully intended and contemplated.

1. A method for controlling the presentation of multi-media content stored on a medium containing a plurality of multi-media content (100-195), the method comprising the steps of:
identifying the multi-media content (100) from an identification associated with the content and/or the medium;
determining a location of a desired one of the plurality of multi-media content (195) in response to a known input and the associated identification;
storing the identification associated with the desired content and/or medium; and
displaying the desired multi-media content (195) from the determined location.

2. The method as recited in claim 1, wherein the step of identifying comprises the step of reading header information from a known location on the medium.

3. The method as recited in claim 2, wherein the header information is selected from the group consisting of a Title, VTS number, Title number, and subtitle.

4. The method as recited in claim 2, wherein the known location is associated with a beginning of the plurality of multi-media content.

5. The method as recited in claim 1, wherein the known input is a response to a request (200).

6. The method as recited in claim 5, wherein the request is provided through an interactive display (210).

7. The method as recited in claim 1, wherein the known input is an extended initiation of a known input.

8. The method as recited in claim 1, wherein the known input is a new input.

9. The method as recited in claim 1; further comprising the step of:
storing information associated with audio settings, color settings, viewing angles, editing materials.

10. An apparatus (400) for controlling the presentation of multi-media content stored on a medium containing a plurality of multi-media content (100-195), the apparatus comprising:
a processor (403) in communication with a memory (404), the processor executing code for:
identifying the multi-media content (195) from an identification associated with the content and/or the medium;
determining a location of a desired one of the plurality of multi-media content (195) in response to a known input and the associated identification;
storing the identification associated with the desired content and/or medium in the memory; and
displaying the desired multi-media content (195) from the determined location.

11. The apparatus as recited in claim 10, wherein the processor further executes a code for:
reading header information (100) from a known location on the medium.

12. The apparatus as recited in claim 11, wherein the header information is selected from the group consisting of a Title, VTS number, Title number, subtitle.

13. The apparatus as recited in claim 11, wherein the known location is associated with a beginning of the plurality of multi-media content.

14. The apparatus as recited in claim 10, wherein the known input is a response to a request (200).

15. The apparatus as recited in claim 14, wherein the request is provided through an interactive display (210).

16. The apparatus as recited in claim 10, wherein the known input is an extended initiation of a known input.

17. The apparatus as recited in claim 10, wherein the known input is a new input.

18. The apparatus as recited in claim 10, wherein the processor further executes a code for:
storing information associated with audio settings, color settings, viewing angles, and editing materials.

19. The apparatus as recited in claim 10, further comprising an input/output device (402) in communication with the processor.

20. The apparatus as recited in claim 10, wherein the code is stored in the memory.

21. The apparatus as recited in claim 10, wherein the plurality of multi-media content is stored on a disc selected from the group consisting of optical and magnetic.

22. The apparatus as recited in claim 10, wherein the plurality of multi-media content is provided over a network.
